(19) United States
(12) Patent Application Publication
(10) Pub. No.: US 2010/0153538 A1
(43) Pub. Date: Jun. 17, 2010

(54) System and Method for Communication Handling and Handoff

(76) Inventors: Janusz HYZIAK, Des Plaines, IL (US); Peisong Huang, Elk Grove Vil, IL (US)

Correspondence Address: MOTOROLA, INC., 1303 EAST ALGONQUIN ROAD, IL01/3RD, SCHAUMBURG, IL, 60196, US

(21) Appl. No.: 12/333,466

(22) Filed: Dec. 12, 2008

(51) Int. Cl. G06F 15/173

(52) U.S. Cl. 709/224

(57) ABSTRACT

A system and method handles communications and handoffs communications. A network component for the communication system comprises a memory and a processor. The memory stores a table of data relating to devices disposed in the communication system. The data includes locations of the devices. The processor is configured to determine a destination for an incoming communication. The processor is further configured to determine a pathway to forward the incoming communication to the destination as a function of the table. The communication system includes a first region in which the network component is configured to manage and a second region in which a further network component is configured to manage.

### FIELD OF THE INVENTION

The present invention relates generally to a system and method for communication handling and handoff. Specifically, the present invention may include a distributed system with at least one communication node that performs the call handling and handoff for a mobile unit that is receiving an incoming communication, transmitting an outgoing communication, or moving from a first region to a second region where the coverage is provided by separate entities.

### BACKGROUND

An enterprise may utilize a private network to handle calls for telephone capable devices associated with the enterprise. The private network may enable intra-enterprise calls to be handled without a need to contact third party service providers. The private network may also enable outgoing calls to be made to devices not associated with the enterprise via the third party service providers with which the enterprise or devices are associated.

The private network may utilize a private branch exchange (PBX) device. An anchor PBX may be used as a central component for the private network. Devices associated with the enterprise may be assigned a number belonging to the anchor PBX. Incoming and outgoing calls are handled via the anchor PBX. The private network may also incorporate regional PBXs if, for example, the private network includes multiple zones. In a system with multiple zones and multiple PBXs, using a single number that belongs to the anchor PBX is preferred. The regional PBXs may also handle outgoing calls. However, handling handoffs and originating calls from locations not associated with the enterprise requires additional time and requires additional resources.

### SUMMARY OF THE INVENTION

The present invention relates to a system and method for communication handling and handoff. A network component for the communication system comprises a memory and a processor. The memory stores a table of data relating to devices disposed in the communication system. The data includes locations of the devices. The processor is configured to determine a destination for an incoming communication. The processor is further configured to determine a pathway to forward the incoming communication to the destination as a function of the table. The communication system includes a first region in which the network component is configured to manage and a second region in which a further network component is configured to manage.

### DESCRIPTION OF THE DRAWINGS

FIG. 1 shows an exemplary embodiment of a private branch exchange system according to the present invention.

FIG. 2 shows a method for handling incoming communications according to an exemplary embodiment of the present invention.

FIG. 3 shows a method for handling handoffs according to an exemplary embodiment of the present invention.

FIG. 4 shows a method for handling outgoing communication according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a system and method for communication handling and handoff for a mobile unit (MU). According to the exemplary embodiments of the present invention, the system may be a communication system that includes a home node device and at least one regional node device for a private enterprise. The communication system may substantially resemble a private branch exchange (PBX) system. The exemplary embodiments of the present invention reduce a resource usage and a transfer time for handling and handoff of communications (e.g., voice, data, etc.) resulting in cost savings and increased wireless coverage. The communication system, the home node, the regional nodes, the MU, and associated methods will be discussed in further detail below.

The communication system may provide connections for internal devices capable of handling voice and/or data communications in an enterprise. The communication system may further provide connections to a public switched telephone network (PSTN), internet service providers for voice over internet protocol (VOIP), or a variety of third party networks such as cellular and/or other wired/wireless networks. The internal devices may be reached within the enterprise through the use of extensions designated as end points in the branch of the communication system. The communication system may be configured to automatically select an outgoing line for communications made by one of the internal devices. The communications may include, for example, telephonic (e.g., voice) communications, data communications, etc.

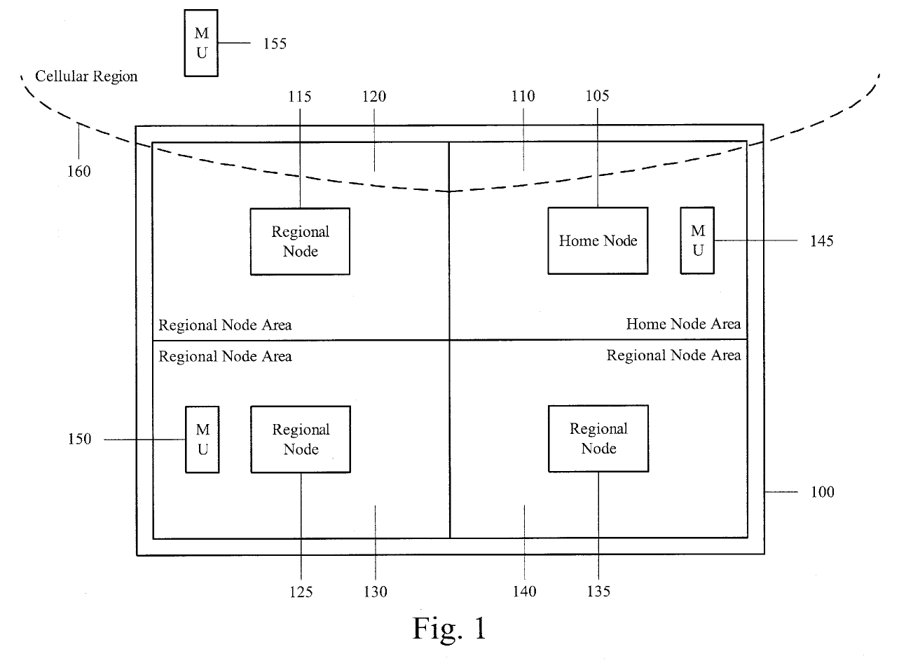

FIG. 1 shows an exemplary embodiment of a communication system according to the present invention. The system may include an overall operating region 100 and a cellular region 160. As illustrated, the overall operating region 100 and the cellular region 160 may overlap. That is, certain areas of the overall operating region 100 may also be supported by the cellular region 160. It should be noted that the partial overlap in FIG. 1 of the overall operating region 100 and the cellular region 160 is only exemplary. In another exemplary embodiment, the cellular region 160 may overlap with the overall operating region 100 wholly. That is, the cellular region 160 may provide a coverage area that encompasses the entire overall operating region 100. In yet another exemplary embodiment, the overall operating region 100 and the cellular region 160 may not overlap.

The overall operating region 100 may be an operating area for an enterprise in which a home node device 105 and regional node devices 115, 125, 135 provide a respective coverage area 110, 120, 130, 140 constituting the overall operating region 100. The node devices may include a variety of functionalities. For example, the node devices may include functionalities relating to a PBX device, devices configured for handoffs, etc. Those skilled in the art will understand that the node device may represent a single unit capable of performing the variety of functionalities or may be a plurality of devices each performing selected ones of the variety of functionalities. It is further noted that in this example, the overall operating region 100 includes coverage areas 110, 120, 130, 140 that are shown as contiguous (e.g., adjacent to each other). However, this is only exemplary. An enterprise may have multiple coverage areas that are not geographically related (e.g., coverage area 110 may be in New York while coverage area 120 may be in Chicago). The coverage areas refer to the locations where an MU associated with the enterprise network has direct wireless communications access to the enterprise network. Those skilled in the art will understand that the implementation of an enterprise network may include various other devices such as access points, wireless switches, servers, network management devices, etc.

In the exemplary embodiment, it will be assumed that within the overall operating region 100, MUs will have wireless access (e.g., WiFi access) to the enterprise network (e.g., via an 802.11a/b/g/n protocol), while outside the overall operating region 100, MUs cannot communicate directly with the enterprise network. For a number of reasons such as cost and efficient use of resources, the owner of the enterprise network may prefer that communications to/from an MU are completed using the WiFi protocol while the MU is in the overall operating region 100 and completed using another protocol such as a cellular protocol when the MU is outside the PBX region 100. However, those skilled in the art will understand that other handoff/call handling scenarios may exist and principles described with respect to the exemplary embodiments may be applied to these other scenarios.

For the MU 145, the home node device 105 may be a central component of the overall operating region. For devices in which the node device 105 establishes as a home, the home node device 105 may determine a routing protocol for incoming communications to internal devices (i.e., devices disposed within the PBX region 100) and correlate a number to all internal devices for outgoing communications. The regional node devices 115, 125, 135 may provide a substantially similar functionality as the home node device 105. For example, the regional node devices 115, 125, 135 may route an incoming communication received from the home node device 105 to an end device. The regional node devices 115, 125, 135 may be connected to the home node device 105 via wired and/or wireless communications. Further functionalities of the node devices will be discussed below. The cellular region 160 may be an operating area for a cellular network. The cellular region 160 may be generated from a cellular tower (not shown).

It should be noted that the terms “home” and “regional” to describe the PBXs are relative. That is, in the present example, MU 145 will be assigned to the home node device 105 making it the home node and the remaining node devices 115, 125, and 135 becoming regional nodes. In other embodiments, MU 145 could establish a different node device as its home making that different node device the home node device for MU 145. Similarly, different MUs may have different home node devices within the same system (e.g., a single node device may act as both home node device for a first MU and a regional node device for a second MU). The following example illustrates the relative state of node devices with relation to two separate MUs. As illustrated, the home node device 105 may be the home node device for the MU 145. Accordingly, the node devices 115, 125, and 135 may be regional node devices for the MU 145. The node device 115 may be a home node device for a further MU. Accordingly, the node devices 105, 125, and 135 may be regional node devices for the further MU.

MUs may be disposed in the overall operating region 100 and/or the cellular region 160. As illustrated, a MU 145 may be disposed in the home node area 110; a MU 150 may be disposed in the regional node area 130; and a MU 155 may be disposed in the cellular region 160. The MUs 145, 150, 155 may be any portable computing device that includes a communication functionality. For example, the MUs 145, 150, 155 may be a mobile computer, a personal digital assistant (PDA), a laptop, a scanner, an RFID reader, an image capturing device, a pager, a cellular phone, etc. The portability may enable the MUs 145, 150, 155 to be moved within a node area; from one of the node areas 110, 120, 130, 140 to a different node area; from one of the node areas 110, 120, 130, 140 to the cellular region 160; or from the cellular region 160 to one of the node areas 110, 120, 130, 140.

It should be noted that the following description in which the system includes MUs disposed therein is only exemplary. The exemplary embodiments of the present invention may further include stationary devices including a communication functionality. For example, the PBX region 100 may include at least one land line phone that is connected to a respective node device 105, 115, 125, 135 depending on a node area in which the land line phone is disposed. It should be noted that the communications may relate generally to any communication made between devices such as voice, text messages, video messages, e-mail, etc.

When a MU enters the overall operating region 100, a registry may be maintained by the home node device 105 indicating known and associated devices disposed in the overall operating region 100 and a specific region within the overall operating region 100 (e.g., home node area 110 or one of the regional node areas 120, 130, 140). For example, the registry may include stationary devices that are disposed in each of the home node area 110 and the regional node areas 120, 130, 140. The registry may also include MUs that are disposed in each of the home node area 110 and the regional node areas 120, 130, 140. As discussed above, each MU may be established with a home PBX (“anchor”). For example, the MU 145 is anchored to the home node device 105. Also, as discussed above, each node device 105, 115, 125, 135 may potentially be home node device for a given MU. Thus, the node devices 115, 125, 135 may also maintain a registry.

A MU may be anchored with a predetermined node device. For example, if the MU is part of the home node area 110, the MU may be anchored to the overall operating region 100 via the home node device 105. In another example, if the MU is part of the node area 130, the MU may be anchored to the overall operating region 100 via the node device 125. Each of the MUs associated with the overall operating region 100 may store a database relating to the home node area 110, the regional node areas 120, 130, 140, and the respective node device responsible for the area. Thus, each of the MUs associated with the overall operating region 100 may be aware that the home node area 110 is maintained by the home node device 105; the regional node area 120 is maintained by the regional node device 115; the regional node area 130 is maintained by the regional node device 125; and the regional node area 140 is maintained by the regional node device 135. It should be noted that the MU may receive the database in a variety of manners. For example, when the MU associates with the overall operating region 100 via the home node device 105 or any of the regional node devices 115, 125, 135, the MU may receive the database or an update to the database from a closest node device or from a system management application. In another example, the MU may receive the database prior to association with the overall operating region 100. The system may be programmed to be configured to usage patterns for the devices.

According to the exemplary embodiments of the present invention, when a MU enters one of the home node area 110 or the regional node areas 120, 130, 140, the MU registers with the respective node device 105, 115, 125, 135. For example, when the MU enters the node region 140, the MU registers with the node device 135. Upon registering, a mobile link table may be updated to include the newly registered MU. The MU may also be assigned a link identification (linkid) in the mobile link table. As will be described in greater detail below, the linkid may be used, for example, to replace the cellular leg with the WiFi leg during handoff. The mobile link table may also include the anchor phone number belonging to its home node device. As discussed above, the node devices 115, 125, 135 may be connected to the home node device 105 and may forward the registering of the MU. The location of the MU within the respective node area may be determined and the home node device 105 may also enter the location of the MU in the registry. In addition, the home node device may include the telephone number of the MU in the entry of the anchor registry. In another exemplary embodiment, the telephone number may be incorporated with the linkid.

According to the exemplary embodiments of the present invention, communication handling for incoming or outgoing communications may be performed via the home node device 105. Furthermore, outgoing communications may be handled by the regional node devices 115, 125, 135, depending on a disposition of the MU. As discussed above, the overall operating region 100 may include devices including a communication functionality. The communication system may receive the incoming/outgoing communications and appropriately direct them to a target destination. The incoming communications may originate from devices within the communication system or from outside the communication system such as from the cellular network while the outgoing communications may originate from devices within the communication system or may be initiated by the node device to complete a communication.

The following description relates to the MU 145 that is anchored to the node device 105. With respect to an incoming communication, whether the incoming communication originates from within the communication system or from outside the communication system, the incoming communication is received by the home node device 105 for processing to determine the destination. If the incoming communication originates from outside the communication system, the incoming communication may be directly received by the home node device 105 by, for example, a connection to a public switch telephone network (PSTN). If the incoming communication originates from within the communication system and, more specifically, from within the home node area 110, the incoming communication may be directly received by the home node device 105. If the incoming communication originates from within the communication system and, more specifically, from within one of the regional node devices 120, 130, 140, the incoming communication may be received by the respective regional node device 115, 125, 135 and forwarded to the home node device 105 or handled locally if the destination is registered with the respective regional home node device.

With regard to the MU 145 anchored to the node device 105, the home node device 105 may determine the identity of the recipient device. Subsequently, using the anchor registry, the home node device 105 may determine the location of the recipient device. The location of the recipient device may enable the home node device 105 to determine a pathway to forward the incoming communication appropriately to the recipient device. For example, if the recipient device is a land line phone anchored to the node device 115, the home node device 105 may forward the incoming communication to the node device 115 which forwards the incoming communication to the land line phone. In another example, if the recipient device is a MU disposed in the home node area 110, the home node device 105 may forward the incoming communication directly to the MU. In a further example, if the recipient device is the MU 150 disposed in node area 130, the home node device 105 may use the anchor registry to determine the MU 150 is disposed in the node area 130 and the home node device 105 will forward the communication to the node device 125 to complete the communication.

The communication system may also be enabled to forward incoming communications to devices not currently in the overall operating region 100. Specifically, when an incoming communication is received by the home node device 105, but the home node device 105 determines that the recipient device is not currently in the overall operating region 100 (e.g., the anchor registry does not include a location for the recipient device within the overall operating region 100), the home node device 105 may appropriately forward the incoming communication to another server for the communication to reach the recipient device. For example, if the recipient device is disposed within the cellular region 160, the home node device 105 may forward the incoming communication to a gateway server or a PSTN in order to reach the recipient device in the cellular region 160. A more detailed description of handling incoming communications will be provided below.

With respect to an outgoing communication in the perspective of the MU 145 anchored to the home node device 105, the home node device 105 may process the outgoing communication originating from devices within the home node area 110, in particular, the MU 145. The home node device 105 may process the outgoing communication in a substantially similar manner as when the home node device 105 received an incoming communication from a device within the PBX system. That is, when the outgoing communication originates from a device within the anchor PBX region 110, the anchor PBX 105 may directly receive the outgoing communication and perform the necessary processes of properly forwarding the communication. Thus, the outgoing communication with reference to the MU 145 may be considered an incoming communication with reference to the home node device 105 when being handled. When the outgoing communication originates from a device within one of the regional node areas 120, 130, 140, in a first example, the respective regional node device 115, 125, 135 may receive the outgoing communication and forward the outgoing communication to the home node device 105 to perform the necessary processes. In a second example, the respective regional node device 115, 125, 135 may receive the outgoing communication and perform the necessary processes. A more detailed description of handling outgoing communications will be provided below.

In addition, according to the exemplary embodiments of the present invention, handoffs may be performed by the communication system. When a MU moves into or out of the overall operating region 100, the MU may initiate a procedure with the communication system to maintain a continuous connection for the MU. For example, if the MU moves from the cellular region 160 to the overall operating region 100, the MU may contact the closest node device to set up a linkid. As discussed above, the linkid may be used to identify the MU by the node devices of the communication system 100. Once the MU is set up with the linkid, the closest node device may perform the handoff. A transfer may be performed by connecting the MU to the node device and dropping a cellular leg from the cellular region 160. A converse operation may be performed when the MU moves from the overall operating region 100 to the cellular region 160. Specifically, the serving node device or the MU may determine that the MU is moving out of the overall operating region 100. The serving node device may establish a connection to the PSTN to perform the handoff. It should be noted that the MU may be equipped with a location system to determine a position of the MU relative to the cellular region 160 and/or the overall operating region 100. Thus, when it is determined that the MU may move from one connection provider (cellular) to another connection provider (PBX), the MU may initiate the handoff. A more detailed description of communication handoffs will be provided below.

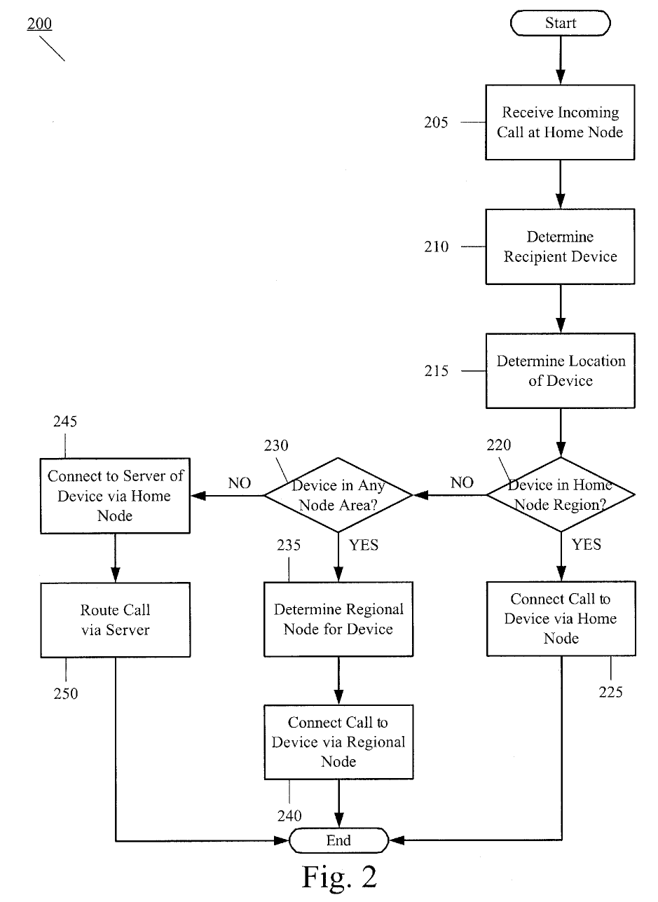

FIG. 2 shows an exemplary method 200 for handling incoming communications according to an exemplary embodiment of the present invention. The method 200 will be discussed with reference to the system described above with reference to FIG. 1. It should be noted that the devices of the communication system may be assumed to already be associated therewith and include, for example, a respective linkid. It should be noted that the term “incoming communication” is used with reference to an end device such as a MU.

In step 205, an incoming communication is received at the home node device 105. When the incoming communication originates from a device outside the communication system, the incoming communication may be directed from an outside server such as a PSTN or a cellular network to the home node device 105. When the incoming communication originates from a device within the communication system and from a device in one of the node areas 120, 130, 140, the incoming communication may be directed from a serving node device and forwarded to the home node device 105. When the incoming communication originates from a device within the communication system and from a device in the home node area 110, the incoming communication may be directed directly to the home node device 105.

In step 210, the home node device 105 determines the recipient device for the incoming communication. As discussed above, the home node device 105 may include a registry including the devices disposed and associated with the overall operating region 100. Each device may include a linkid associated therewith. The incoming communication may include data indicating the recipient device interpreted by the home node device 105. Once determined, the home node device 105 may reference the registry to determine the identity of the recipient device. Subsequently, in step 215, the home node device 105 may further determine the location of the recipient device.

In step 220, a determination is made whether the recipient device is in the home node area 110. The determination may be used to minimize an amount of resources used and to lower costs. In particular, when an expectation exists that the recipient device is disposed in the home node area 100, the determination may be made in a smallest area. If step 220 determines that the recipient device is within the home node area 110, the method 200 continues to step 225 where the incoming communication is forwarded to the recipient device directly from the home node device 105.

If step 220 determines that the recipient device is not in the home node area 110, the method 200 continues to step 230 where a determination is made whether the recipient device is disposed in any of the regional node areas 120, 130, 140. The method 200 continues to step 235 where the home node device 105 uses the location determined in step 215 to identify the node device 115, 125, 135 that is currently serving the recipient MU. For example, if the recipient device is in the regional node area 130, the home node device 105 determines that the serving node is the regional node device 125. Subsequently, in step 240, the incoming communication is forwarded to the serving node device to forward the incoming communication to the recipient device.

Returning to step 230, if step 230 determines that the recipient device is not within any of the node areas including the home node area (i.e., recipient device is not disposed in the overall operating region 100), the method 200 continues to step 245. The home node device 105 may also determine that the recipient device is not within the overall operating area 100 if the recipient device is not included in the registry. In step 245, the home node device 105 may connect to or query a server of the recipient device such as a registrar, a PSTN, or a cellular network. Subsequently, in step 250, the incoming communication may be routed to a gateway server, PSTN, or other system to be forwarded to the recipient device.

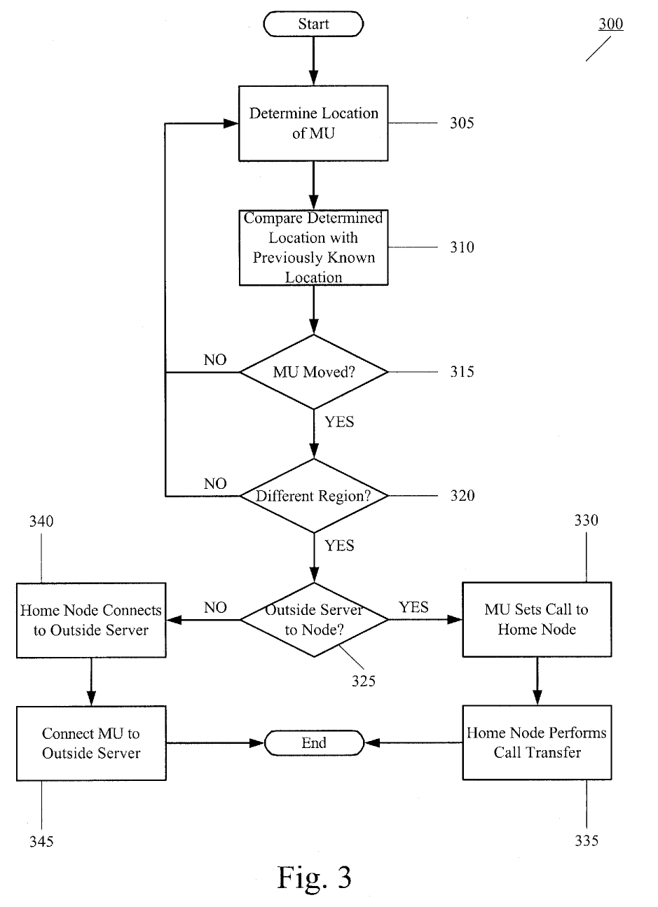

FIG. 3 shows an exemplary method 300 for handling handoffs according to an exemplary embodiment of the present invention. The method 300 will be described with reference to the system above with reference to FIG. 1. It should be noted that the device in which the handoff is performed may be assumed to be a MU.

In step 305, a location of the MU is determined. The location of the MU may be determined by the home node device or one of the regional node devices (when the MU is disposed in the PBX region 100), may be determined by the server of a different network (e.g., when the MU is disposed in the cellular region 160), or may be determined by the MU. The location determining may be performed using conventionally known methods.

In step 310, a comparison is determined from the determined location and a previously known location. This comparison may indicate whether the MU is being moved. Thus, in step 315, a determination is made whether the MU has moved. If the MU has not moved, the method 300 returns to step 305 where the location of the MU is determined. It should be noted that the return to step 305 may include a timer or other criteria so that the location is determined at predetermined times. It should also be noted that further factors may be considered to determine movement of the MU. For example, a comparison of the radio signal environment may be used. Accordingly, communications conditions may also be determined at predetermined times.

If step 315 determines that the MU has moved, the method 300 continues to step 320 where a determination is made whether the MU has moved into a different region. The different region refers to whether the connection provider is going to change. Thus, the determination of step 320 may indicate whether a handoff is required. If step 320 determines that the MU is not being moved into a different region, the method 305 returns to step 305.

In step 325, a determination is made whether the move in regions is from an outside server to within the overall operating region. When the MU moves from an outside server (e.g., cellular region 160) to the overall operating region 100, the method 300 continues to step 330 where the MU sets a call to the home node device 105. As described above, when the MU registers with one of the node devices 105, 115, 125, 135, it receives a linkid in the mobile link table. The MU uses this linkid to establish a call to the home node device 105. The contact with the home node device 105 may indicate that the MU may now receive communications via the WiFi network and the cellular connection my be dropped. Thus, in step 335, the home node device 105 may perform the handoff. The handoff includes the home node device 105 monitoring, for example, the dual-tone multi-frequency (dtmf) tones, and linking the current communication via the WiFi leg of the PBX system with the existing cellular leg for a remainder of the communication session.

If step 325 determines that the MU moves from the overall operating region to outside the overall operating region, the method 300 continues to step 340 where the home node device connects to the outside server (or other device) to which the MU will move. For example, the home node device 105 may place a call to the PSTN or cellular network. In step 345, the outside server may establish a connection with the MU and the WiFi leg may be dropped to complete the handoff (on the side of the communication system according to the present invention).

It should be noted that the method 300 may include additional steps that may be separate from the establishing a connection and the dropping of a connection. For example, the MU may include anticipatory algorithms. If the MU is disposed outside the overall operating region 100, the MU may determine which node region the MU will most likely enter. If the MU is attempting to place an outgoing communication, the MU may decide that the outgoing communication is to be processed by the node device maintaining the closest PBX region in which the MU will move. The direction and speed of the MU may be factors that the MU considers when making the determination. In such an exemplary embodiment, the handoff may be simplified as the MU is already having the communication processed by the respective node device.

In a further exemplary embodiment, if the MU that is to receive an incoming communication is disposed outside the overall operating region 100, the destination of the incoming communication may determine whether the communication should be forwarded to a third part provider or to a node device. For example, the direction and speed of the destination MU may indicate that the destination MU will move into a node area. This determination may be made by the home node device. Thus, the home node device may forward the incoming communication to the respective node device that maintains the node area in which the destination MU will move.

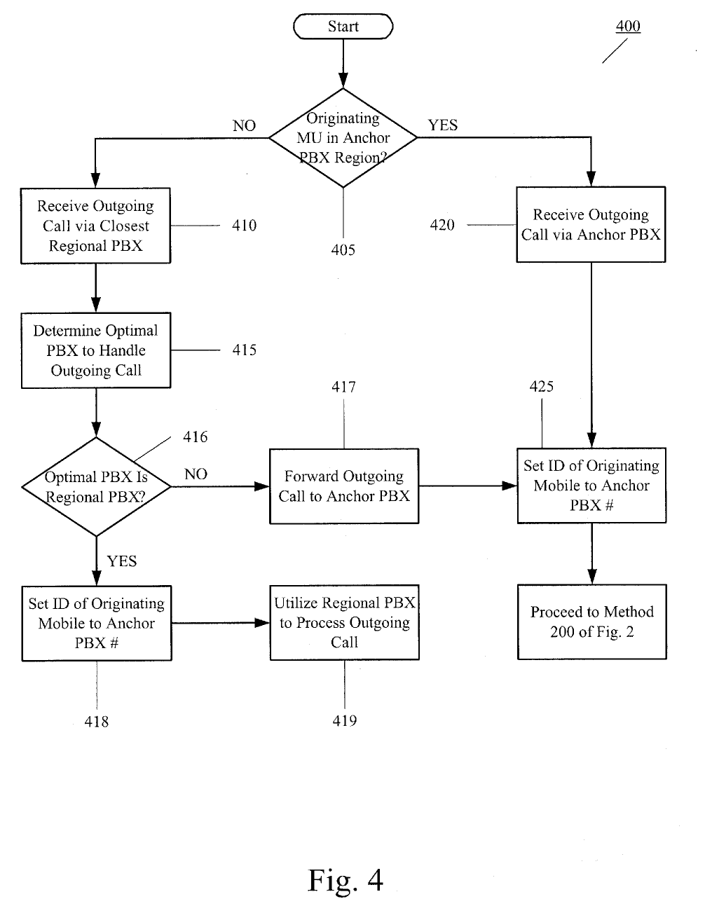

FIG. 4 shows an exemplary method 400 for handling outgoing communications according to an exemplary embodiment of the present invention. The method 400 will be discussed with reference to the system described above with reference to FIG. 1. It should again be noted that the devices of the communication system may be assumed to already be associated therewith and include, for example, a respective linkid. It should also be noted that the term “outgoing communication” is used with reference to an end device such as a MU.

In step 405, a determination is made whether the originating MU anchored to the home node device 105 is disposed in the home node area 110. In the exemplary embodiment, the originating MU refers to the MU attempting to place a communication. If step 405 determines that the originating MU is not disposed in the home node area 110 and further determines that the originating MU is disposed in one of the regional node areas 120, 130, 140, then the method 400 continues to step 410.

In step 410, the regional node device managing the respective regional node area in which the originating MU is disposed receives the outgoing communication from the originating MU. Thus, if the originating MU is disposed in regional node area 120, the regional node device 115 receives the outgoing communication. Subsequently, in step 415, a determination is made regarding which node device is most efficient to handle the outgoing communication. That is, there may be scenarios where the outgoing communication is most efficiently handled by the regional node device or the home node device. Predetermined factors may be input to make this determination. For example, a predetermined factor may be the destination of the outgoing communication. If the destination of the outgoing communication is located within the regional node area that received the outgoing communication, the regional node device may be the most appropriate node device to handle the outgoing communication.

Thus, in step 416, a determination is made whether the optimal node device to handle the outgoing communication is the regional node device that received the outgoing communication. If the regional node device is not optimal node device, then the method 400 continues to step 417 where the outgoing communication is forwarded from the regional node device to the home node device. The home node device refers to the node device in which the originating MU is anchored. Returning to step 405, if step 405 determines that the originating MU is disposed in the home node area, then the home node device may receive the outgoing communication directly from the originating MU.

Once the home node device receives the incoming communication from a regional node device (via steps 410-417) or from the originating MU (via step 420), the method 400 continues to step 425. In step 425, the home node device 105 prepares the outgoing communication by setting an identification as the home node device number. The identification may refer to a return call number or caller ID. The home node device number may refer to a specific telephone number assigned to the home node device. Once the outgoing communication has been set up by the home node device, the method 400 may continue to perform method 200 in which the steps entail handling the outgoing communication in a substantially similar manner as an incoming communication at the home node device. Accordingly, the outgoing communication of method 400 may be considered an incoming communication for method 200.

Returning to step 416, if the optimal node device is determined to be the regional node device, then the method 400 continues to step 418 where the regional node device prepares the outgoing communication by setting an identification as the home node device number. For example, the MU 145 may be anchored to the home node device 105. The MU 145 may further be disposed in the regional node area 120. Thus, the regional node device 115 may set the identification as the number of the home node device 105. Subsequently, in step 419, the regional node device processes the outgoing communication. The processing of the outgoing communication by the regional node device may be substantially similar to the actions performed by the home node device in the method 200.

It should be noted that the method 400 may include additional steps. As described above, the method 400 assumes that when the MU is not disposed in the home node area 110, the MU is aware which regional node device it is most closely disposed. However, in another exemplary embodiment, the MU may be capable of determining a location of the MU relative to the overall operating area 100. The location may be determined using a variety of conventional methods (e.g., triangulation, GPS, RSSI, etc.). Using, for example, a list of network node devices and a topography map of the overall operating area 100, the MU may determine which node device is most closely disposed to the MU. It should be noted that it may be assumed that the most closely disposed node device may be the most appropriate node device to handle incoming and outgoing communications for the MU. Furthermore, in such an embodiment, the MU may have moved, thereby requiring the new location of the MU to be determined. When the MU attempts to contact the closest node device to make an outbound communication, the PBX may further forward the location of the MU to the home node device to update the position of the MU in the mobile link table.

The exemplary embodiments of the present invention provide a handling system for a communication system. The home node device may process incoming and outgoing communications so that they may be appropriately handled by processing a correct pathway to forward the communication to the proper recipient. The other node devices of the system may assist in handling of the communications when the system includes additional node areas outside the home node area. The communication system may also provide a handoff so that a MU moving into or out of the overall operating region may maintain a connection.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A network component for a communication system, comprising:
a memory storing a table of data relating to devices disposed in the communication system, the data including locations of the devices; and
a processor configured to determine a destination for an incoming communication, the processor being further configured to determine a pathway to forward the incoming communication to the destination as a function of the table,
wherein the communication system includes a first region in which the network component is configured to manage and a second region in which a further network component is configured to manage.

2. The network component of claim 1, wherein, when a location of the destination is within the first region, the network component directly forwards the incoming communication to the destination.

3. The network component of claim 1, wherein, when a location of the destination is within the second region, the network component forwards the incoming communication to the further network component, the further network component forwarding the incoming communication to the destination.

4. The network component of claim 1, wherein the network component may be configured to be connected to a network outside the communication system.

5. The network component of claim 4, wherein the incoming communication originates one of from one of the devices of the communication system and from the network outside the PBX system.

6. The network component of claim 4, wherein the incoming communication is forwarded to one of one of the devices of the communication system when the location of the destination is within the communication system and the network outside the communication system when the location of the destination is outside the communication system.

7. A system, comprising:
a network component for a communication system configured to handle an incoming communication for an associated device disposed in a region managed by the network component, the network component further being configured to determine a destination for the incoming communication, the network component determining a pathway to forward the incoming communication to the destination as a function of a table stored on the network component that stores locations of devices disposed in the communication system; and
a mobile device disposed in the communication system,
wherein the communication system includes a first region in which the network component is configured to manage and a second region in which a further network component is configured to manage.

8. The system of claim 7, wherein the mobile device generates the incoming communication.

9. The system of claim 8, wherein, when the mobile device is disposed in the first region, the mobile device forwards the incoming communication directly to the network component.

10. The system of claim 8, wherein, when the mobile device is disposed in the second region and is anchored to the network component, the mobile device forwards the incoming communication to the further network component, the further network component forwarding the incoming communication to the network component.

11. The system of claim 7, wherein the mobile device is the destination for the incoming communication and is anchored to the network component.

12. The system of claim 11, wherein the incoming communication originates one of from within the communication system and from a network outside the communication system in which the network component is connected.

13. The system of claim 12, wherein the incoming communication is forwarded one of directly from the network component to the mobile device when the mobile device is disposed in the first region and from the network component to the further network component, the further network component forwarding the incoming communication to the mobile device when the mobile device is disposed in the second region.

14. A system, comprising:
a first network component configured to manage a first region of a communication system; and
a second network component configured to manage a second region of the communication system,
wherein the first network component is configured to handle an incoming communication for a device anchored thereto, the first network component being further configured to determine a destination for the incoming communication, the first network component determining a pathway to forward the incoming communication to the destination as a function of a table stored on the first network component that stores locations of devices disposed in the PBX system.

15. The system of claim 14, wherein, when the destination is disposed in the first region, the first network component forwards the incoming communication directly to the destination.

16. The system of claim 14, wherein, when the destination is disposed in the second region, the first network component forwards the incoming communication to the second network component, the second network component forwarding the incoming communication to the destination.

17. A method, comprising:
receiving an incoming communication at a network component for a communication system from a device disposed in the communication system and anchored to the network component;
determining, by the network component, a pathway to forward the incoming communication to a destination as a function of a table stored on the network component that stores locations of devices disposed in the communication system; and
forwarding the incoming communication to the destination in accordance to the pathway.

18. The method of claim 17, wherein the communication system includes a first region in which the network component is configured to manage and a second region in which a further network component is configured to manage.

19. The method of claim 18, wherein, when the destination is in the first region, the forwarding includes a direct transmission from the network component to the destination.

20. The method of claim 18, wherein, when the destination is in the second region, the forwarding includes a transmission from the network component to the further network component, the further network component forwarding the incoming communication to the destination.
